(19) United States
(12) Patent Application Publication
(10) Pub. No.: US 2016/0311091 A1
(43) Pub. Date: Oct. 27, 2016

(54) Tool coupler

(71) Applicant: Tzu-Chien Wang, Tainan City (TW)

(72) Inventor: Tzu-Chien Wang, Tainan City (TW)

(73) Assignee: Compass Corp. (The president is Chen, Su-Chiu), Tainan City (TW)

(21) Appl. No.: 14/696,427

(22) Filed: Apr. 25, 2015

(51) Int. Cl. B25B 23/00; B23B 31/22

(52) U.S. Cl. CPC B25B 23/0035; B23B 31/22

(57) ABSTRACT

A tool coupler includes a front stop ring mounted around a coupler having a coupling hole receiving a pressing seat. First and second positioning balls are respectively received in first and second radial holes of the coupler. The pressing seat includes a receptacle receiving a magnet and includes an elastic portion abutting against a bottom wall of the coupling hole. The pressing seat includes a recessed portion and a pressing portion for pressing against the second positioning ball. A sleeve body receives the coupler and includes an inclined guiding face for pressing against the first positioning ball. A rear stop ring is fixed in the receiving hole of the sleeve body and includes a side stop wall for pressing against the second positioning ball and a recessed section for partially receiving the second positioning ball. A spring is mounted between the front stop ring and the rear stop ring.

### BACKGROUND OF THE INVENTION

The present invention relates to a tool coupler and, more particularly, to a tool coupler for coupling with a bit while providing enhanced operational stability at reduced component costs.

A conventional tool coupler generally includes a coupling hole for coupling with different types of bits to provide enhanced utility. With continuous improvement, the tool coupler includes a mechanism allowing rapid detachment of the bit. FIGS. 6 and 7 show a conventional tool coupler including a coupler 1′, a pressing device 2′, and a sleeve device 3′. A coupling hole 11′ is defined in a front end of the coupler 1′ for coupling with a bit 4′. A coupling rod 10′ is provided on a rear end of the coupler 1′ for coupling with a hand tool, a pneumatic tool, or an electric tool. The coupler 1′ further includes radial holes 12′ and 13′ respectively in a front end and an intermediate portion of an outer periphery thereof. Steel balls 121′ and 131′ are respectively received in the radial holes 12′ and 13′. A first shoulder 14′ is formed on an inner periphery of the coupling hole 11′. A groove 15′ is defined in the outer periphery of the coupler 1′ and receives a stop ring 16′.

The pressing device 2′ includes a pressing seat 21′, a magnet 22′, and a spring 23′. The pressing seat 21′ is received in the coupling hole 1′, is located behind the first shoulder 14′, and is movable in an axial direction of the coupling hole 11′. The pressing seat 21′ includes a receptacle 211′ in a central portion thereof. The pressing seat 21′ further includes a recessed portion 212′ on a front end of an outer periphery thereof. A pressing side 213′ is provided on a rear end of the outer periphery of the pressing seat 21′ for pressing against the steel balls 131′. The pressing side 213′ is at a right angle (indicated by a in FIGS. 6 and 7) to the recessed portion 212′. The pressing seat 21′ further includes a second shoulder 214′ abutting against the first shoulder 14′. The magnet 22′ is mounted in the receptacle 211′. The spring 23′ has two ends respectively abutting against a bottom wall of the coupling hole 11′ and the magnet 22′ and provides elasticity for movement of the pressing device 2′. The sleeve device 3′ includes a sleeve body 31′, a rear stop ring 32′, a spring 33, and a front stop ring 34′. The sleeve body 31′ is mounted around the coupler 1′ and includes a receiving hole 311′ in a central portion thereof. The receiving hole 311′ includes a front portion having a stop wall 312′ with a reduced diameter. The stop wall 312′ can press against the steel balls 131′. The receiving hole 311′ further includes a recessed section 313′ at a rear end thereof and having an enlarged diameter. The spring 33′ is mounted between the rear stop ring 32′ and the stop ring 16′ and provides elasticity for movement of the sleeve body 31′. The front stop ring 34′ is mounted in the front end of the receiving hole 311′ and can press against the front end of the coupler 1′.

With reference to FIG. 7, when the bit 4′ is inserted into the coupling hole 11′, the pressing device 2′ is moved towards the rear end of the coupling hole 11′ and compresses the spring 23′, and the recessed portion 212′ of the pressing seat 21′ is moved to a location aligned with the steel balls 131′. Thus, the steel balls 131′ can move into the recessed portion 212′, and the sleeve body 3′ is moved rearwards by the spring 33′, such that the stop wall 312′ presses against the steel balls 131′. Furthermore, the front stop ring 34′ presses against the front end of the coupler 1′. Furthermore, the steel balls 121′ engage with engagement grooves 41′ of the bit 4′.

When it is desired to remove the bit 4′, the sleeve body 31′ is moved forwards to a position shown in FIG. 6, and the steel balls 131′ move to the recessed section 313′, such that the pressing seat 21′ is moved forwards by the spring 23′, and the bit 4′ is moved outwards to permit rapid removal of the bit 4′ from the coupling hole 11′.

However, the above structure has the following advantages. Firstly, two springs 23′ and 34′, the front stop ring 16′, and the front and rear stop ring 34′ and 32′ are required, which is complicated in structure and inconvenient to assemblage while increasing the component costs and the probability of malfunction. Secondly, when the bit 4′ is inserted into the coupling hole 11′, if the steel balls 131′ cannot rapidly move towards the recessed portion 212′, smooth rearward movement of the sleeve body 31′ cannot be obtained. Thirdly, when the sleeve body 31′ is pushed forwards for removing the bit 4′, the right angle a between the pressing side 213′ and the recessed portion 212′ presses against the steel balls 131′ to move the steel balls 131′ radially outwards. However, the movement at the right angle a is generally not smooth.

### BRIEF SUMMARY OF THE INVENTION

An objective of the present invention is to provide a tool coupler providing enhanced operational stability while reducing the component costs.

A tool coupler according to the present invention includes a coupler having a front end and a rear end. The front end of the coupler includes a coupling hole. A coupling rod is provided on the rear end of the coupler. The coupler further includes first and second radial holes defined in an outer periphery of the coupler and intercommunicated with the coupling hole. First and second positioning balls are respectively received in the first and second radial holes. A front stop ring is mounted around the outer periphery of the coupler and is located between the first and second radial holes. A pressing device includes a pressing seat and a magnet. The pressing seat is mounted in a rear end of the coupling hole. The pressing seat includes a front end having a receptacle. The pressing seat further includes a rear end having an elastic portion abutting against a bottom wall of the coupling hole. The front end of the pressing seat includes a recessed portion at a side of the receptacle. The pressing seat further includes a pressing portion behind the recessed portion. The pressing portion is configured for pressing against the second positioning ball. The magnet is mounted in the receptacle of the pressing seat. A sleeve device includes a sleeve body, a rear stop ring, and a spring. The sleeve body includes a receiving hole in a central portion thereof. The receiving hole receives the front end of the coupler. The receiving hole of the sleeve body includes an inner periphery having a front portion with a second inclined guiding face. The second inclined guiding face is configured for pressing against the first positioning ball. The rear stop ring is fixed in a rear end of the receiving hole of the sleeve body. The rear stop ring includes a front end having a front stop wall. The rear stop ring further includes an inner periphery having a side stop wall and a recessed section. The side stop wall is configured for pressing against the second positioning ball.

The recessed section is configured for partially receiving the second positioning ball. The spring includes two ends respectively abutting against the front stop ring and the front stop wall of the rear stop ring. The spring provides elasticity for movement of the sleeve body.

The pressing seat can be made of plastic material, and the elastic portion can be helical.

The first and second positioning balls can be steel balls. The recessed portion of the pressing seat can include a notch intercommunicated with the receptacle. The magnet has a side exposed via the notch.

The pressing seat can further include a first inclined guiding face between recessed portion and the pressing portion. The first inclined guiding face inclines rearwards and radially outwards.

The recessed section of the rear stop ring can include a front end having a front inclined guiding side.

The coupling hole of the coupler can include an inner periphery having a shoulder located in front of the second radial hole. A portion of the coupling hole in front of the shoulder has a diameter larger than a diameter of another portion of the coupling hole behind the shoulder.

The outer periphery of the coupler can include a groove between the first and second positioning radial holes, and the front stop ring is received in the groove.

The receiving hole of the sleeve body can include a receiving portion behind the second inclined guiding face. The receiving portion has an enlarged diameter larger than a diameter of a front portion of the receiving hole. The spring is received in the receiving portion.

The present invention will become clearer in light of the following detailed description of illustrative embodiments of this invention described in connection with the drawings.

### DESCRIPTION OF THE DRAWINGS

FIG. 1 is an exploded, perspective view of a tool coupler according to the present invention.

FIG. 2 is a perspective view of the tool coupler of FIG. 1 after assembly.

FIG. 3 is a partial, cross sectional view of the tool coupler of FIG. 2.

FIG. 4 is a view similar to FIG. 3, with a bit coupled with the tool coupler.

FIG. 5 is a view similar to FIG. 4, illustrating operation for removing the bit.

FIG. 6 is a partial, cross sectional view of a conventional tool coupler.

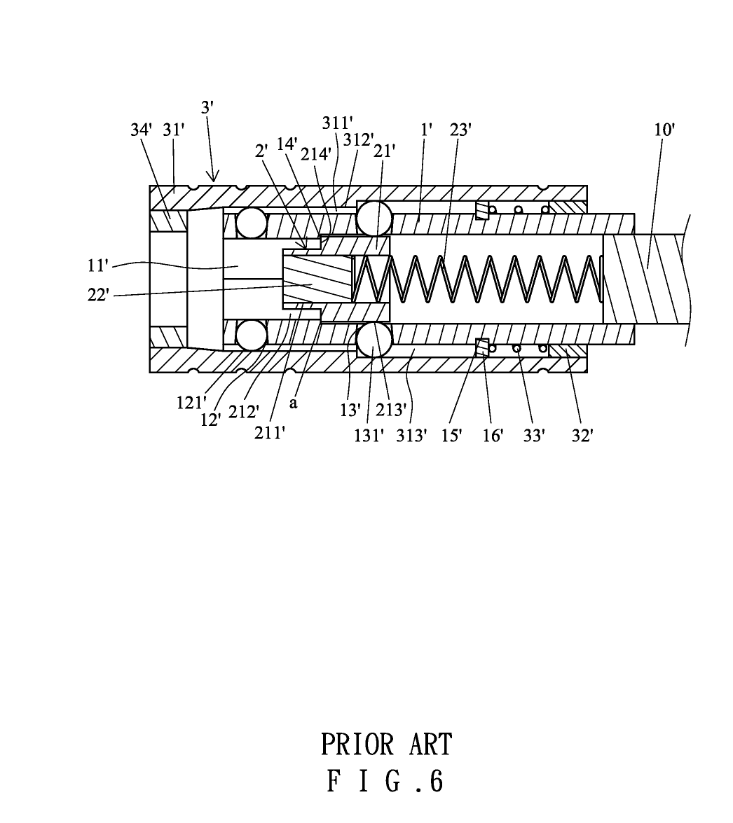

FIG. 7 is a view similar to FIG. 6, with a bit coupled with the tool coupler.

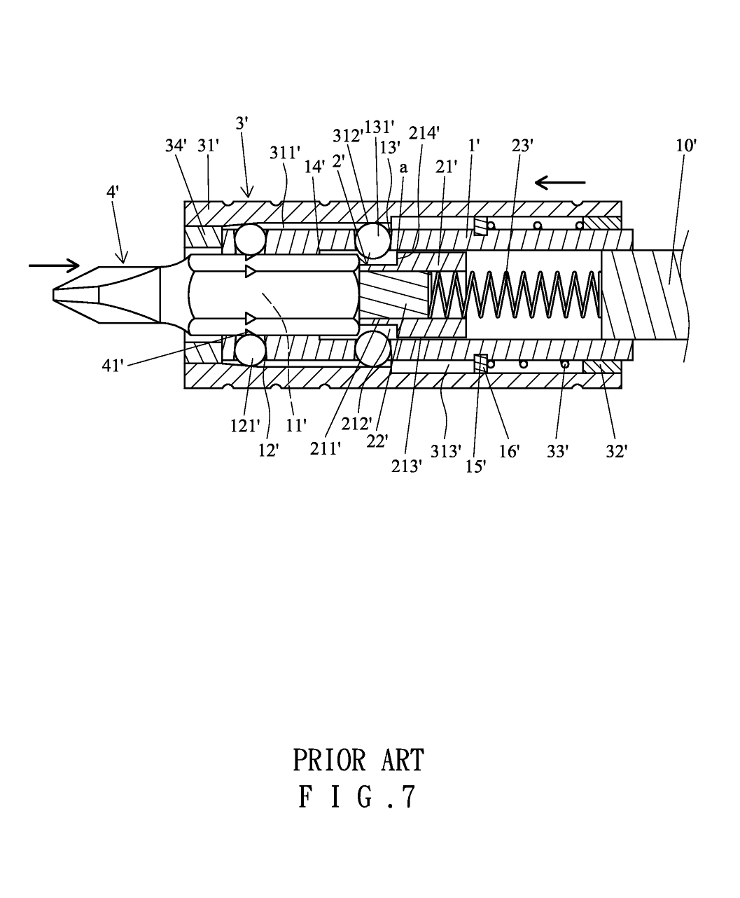

### DETAILED DESCRIPTION OF THE INVENTION

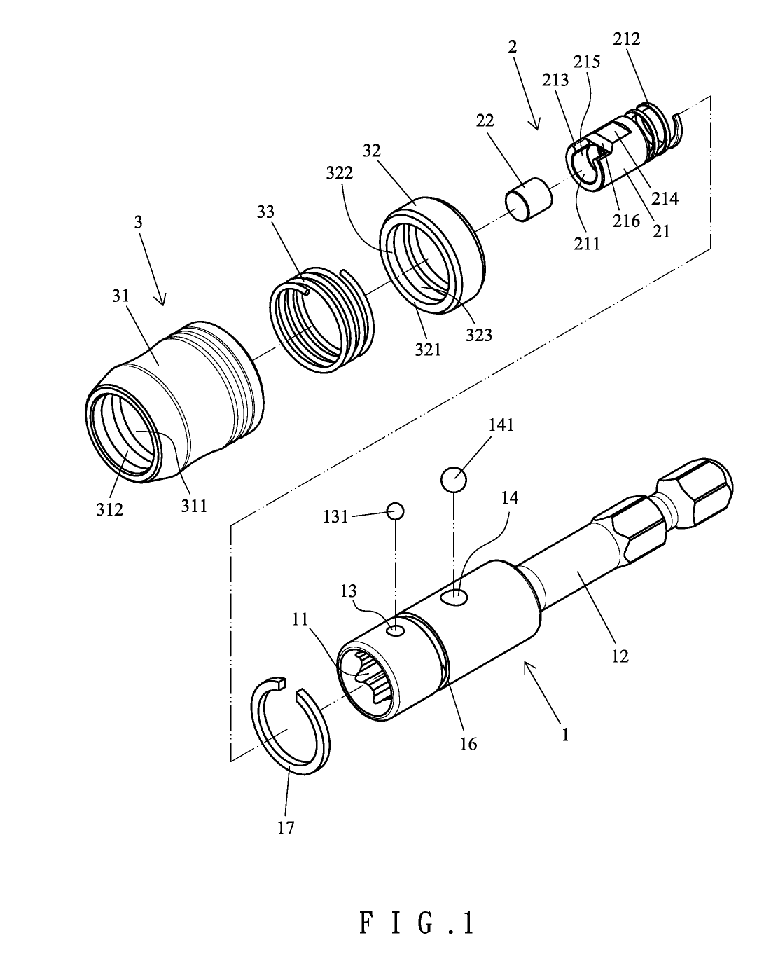

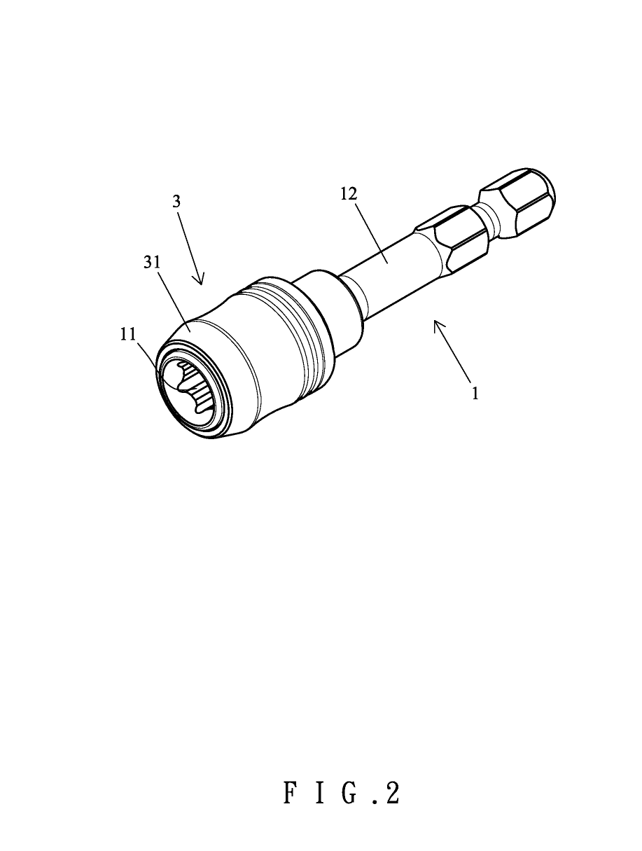

With reference to FIGS. 1-4, a tool coupler according to the present invention includes a coupler 1, a pressing device 2, and a sliding device 3. The coupler 1 includes a front end having a coupling hole 11 that is polygonal. A coupling rod 12 is provided on a rear end of the coupler 1. The coupler 1 further includes first and second radial holes 13 and 14 defined in an outer periphery of the coupler 1 and intercommunicated with the coupling hole 11. First and second positioning balls 131 and 141 are respectively received in the first and second radial holes 13 and 14 and can be steel balls. The coupling hole 11 of the coupler 1 includes an inner periphery having a shoulder 15 located in front of the second radial hole 14. A portion of the coupling hole 11 in front of the shoulder 15 has a diameter larger than a diameter of another portion of the coupling hole 11 behind the shoulder 15. A bottom end of a bit 4 can abut against the shoulder 15. A groove 16 is defined in the outer periphery of the coupler 1 and is located between the first and second positioning radial holes 131 and 141. A front stop ring 17 is received in the groove 16.

A pressing device 2 includes a pressing seat 21 and a magnet 22. The pressing seat 21 is mounted in a rear end of the coupling hole 11 and is made of plastic material. The pressing seat 21 includes a front end having a receptacle 211. The pressing seat 21 further includes a rear end having an elastic portion 212 abutting against a bottom wall of the coupling hole 11. The elastic portion 212 is helical. The front end of the pressing seat 21 includes a recessed portion 213 at a side of the receptacle 211. The pressing seat 21 further includes a pressing portion 214 behind the recessed portion 213. The pressing portion 214 is configured for pressing against the second positioning ball 141. The recessed portion 213 of the pressing seat 21 includes a notch 215 intercommunicated with the receptacle 211. The pressing seat 21 further includes a first inclined guiding face 216 between recessed portion 213 and the pressing portion 214. The first inclined guiding face 216 inclines rearwards and radially outwards. The magnet 22 is mounted in the receptacle 211 of the pressing seat 21 and has a side exposed via the notch 215.

The sleeve device 3 includes a sleeve body 31, a rear stop ring 32, and a spring 33. The sleeve body 31 includes a receiving hole 311 in a central portion thereof. The receiving hole 311 receives the front end of the coupler 1. The receiving hole 311 of the sleeve body 31 includes an inner periphery having a front portion with a second inclined guiding face 312. The second inclined guiding face 312 is configured for pressing against the first positioning ball 131. The receiving hole 311 of the sleeve body 31 includes a receiving portion 313 behind the second inclined guiding face 312. The receiving portion 313 has an enlarged diameter larger than a diameter of a front portion of the receiving hole 311. The rear stop ring 32 is fixed in a rear end of the receiving hole 311 of the sleeve body 31. The rear stop ring 32 includes a front end having a front stop wall 321. The rear stop ring 32 further includes an inner periphery having a side stop wall 322 and a recessed section 323. The side stop wall 322 is configured for pressing against the second positioning ball 141. The recessed section 323 is configured for partially receiving the second positioning ball 141. The recessed section 323 of the rear stop ring 32 includes a front end having a front inclined guiding side 324. The spring 33 is received in the receiving portion 313. The spring 33 includes two ends respectively abutting against the front stop ring 17 and the front stop wall 321 of the rear stop ring 32 and provides elasticity for movement of the sleeve body 31.

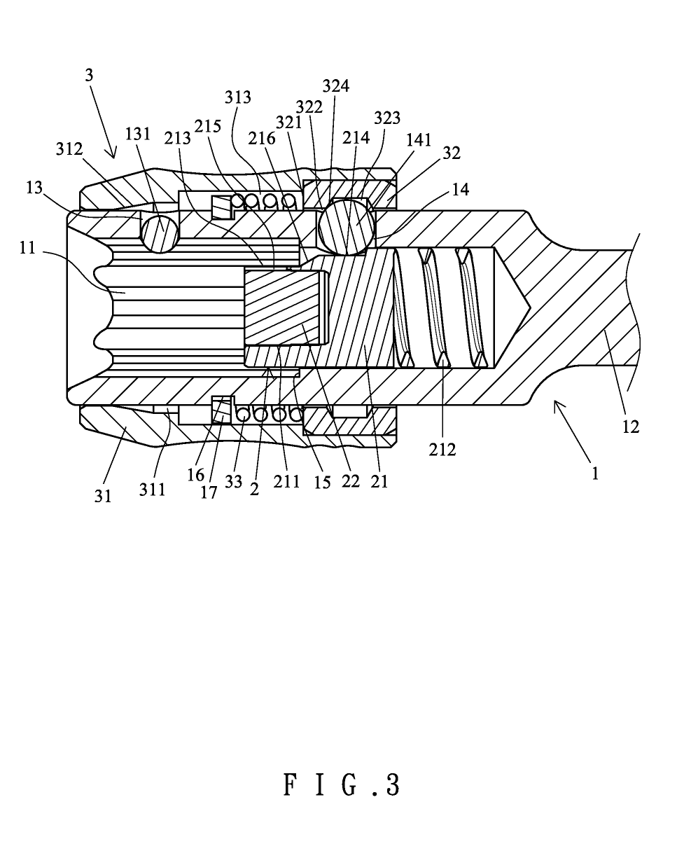

With reference to FIG. 3, before the bit 4 is coupled with the tool coupler according to the present invention, the pressing portion 214 presses against the second positioning ball 141. A portion of the second positioning ball 141 is received in the recessed section 323 of the rear stop ring 32, and the spring 33 is compressed.

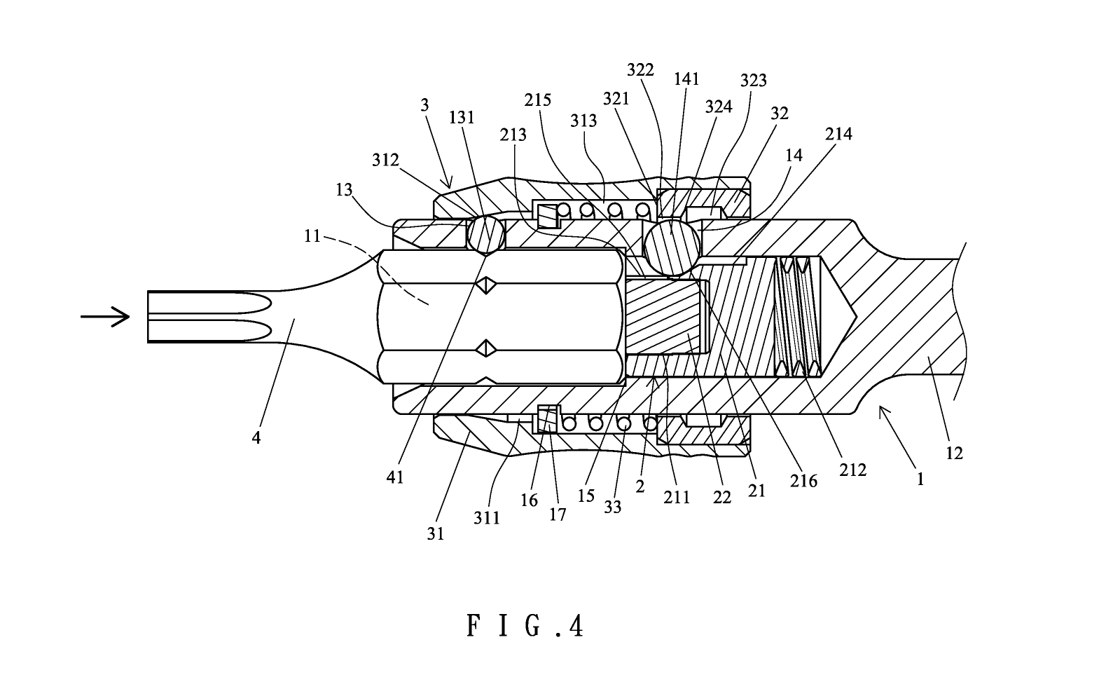

With reference to FIG. 4, when the bit 4 is inserted into the coupling hole 11, the pressing seat 21 moves rearwards to compress the elastic portion 212. The bottom end of the bit 4 is attracted by the magnet 22. The recessed portion 213 of the pressing seat 21 is aligned with the second positioning ball 141. The first positioning ball 131 is pressed by the second inclined guiding face 312 to engage with an engagement groove 41 of the bit 4. The insertion depth of the bottom end of the bit 4 is restrained by the shoulder 15 of the coupling hole 11. The attractive force of the magnet 22 attracts the second positioning ball 141 to move towards the recessed portion 213 of the pressing seat 21. The front inclined guiding side 324 assists in easy rearward movement of the sleeve body 31 under the action of the elastic force of the spring 33, providing smooth movement. Furthermore, the side stop wall 322 of the rear stop ring 32 abuts against the second positioning ball 141 to prevent forward movement of the pressing seat 21.

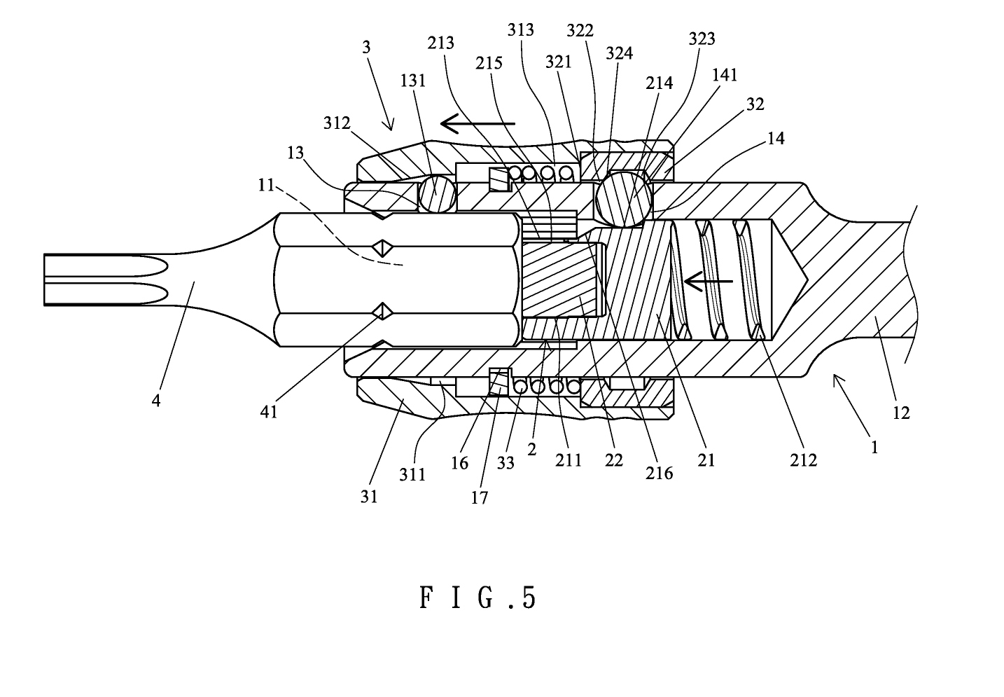

With reference to FIG. 5, when it is desired to remove the bit 4, the sleeve body 31 is moved forwards, such that the second inclined guiding face 312 no longer presses against the first positioning ball 131. Furthermore, the elastic force of the elastic portion 212 of the pressing seat 21 pushes the bit forward 4 to permit easy removal of the bit 4. When the pressing seat 21 moves forwards, the first inclined guiding face 216 presses against the second positioning ball 141 and moves the second positioning ball 141 radially outwards into the recessed section 323 of the rear stop ring 32, providing smooth, stable operation.

The tool coupler according to the present invention includes only one spring 33. Furthermore, the rear stop ring 32 both functions of positioning the second positioning ball 141 and pressing against the spring 33. The whole structure of the tool coupler is much simpler than the conventional structure, saving the costs, permitting easy assemblage, and reducing the probability of malfunction.

Furthermore, the first positioning ball 131 can be attracted by the magnet 22. Furthermore, the first inclined guiding face 216 of the pressing seat 21 and the front inclined guiding side 324 of the rear stop ring 32 greatly improves the operational smoothness and stability while preventing the sleeve body 31 from getting stuck during operation.

Although specific embodiments have been illustrated and described, numerous modifications and variations are still possible without departing from the scope of the invention. The scope of the invention is limited by the accompanying claims.

1. A tool coupler comprising:
a coupler including a front end and a rear end, with the front end of the coupler including a coupling hole, with a coupling rod provided on the rear end of the coupler, with the coupler further including first and second radial holes defined in an outer periphery of the coupler and intercommunicated with the coupling hole, with first and second positioning balls respectively received in the first and second radial holes, and with a front stop ring mounted around the outer periphery of the coupler and located between the first and second radial holes;
a pressing device including a pressing seat and a magnet, with the pressing seat mounted in a rear end of the coupling hole, with the pressing seat including a front end having a receptacle, with the pressing seat further including a rear end having an elastic portion abutting against a bottom wall of the coupling hole, with the front end of the pressing seat including a recessed portion at a side of the receptacle, with the pressing seat further including a pressing portion behind the recessed portion, with the pressing portion configured for pressing against the second positioning ball, and with the magnet mounted in the receptacle of the pressing seat; and
a sleeve device including a sleeve body, a rear stop ring, and a spring, with the sleeve body including a receiving hole in a central portion thereof, with the receiving hole receiving the front end of the coupler, with the receiving hole of the sleeve body including an inner periphery having a front portion with a second inclined guiding face, with the second inclined guiding face configured for pressing against the first positioning ball, with the rear stop ring fixed in a rear end of the receiving hole of the sleeve body, with the rear stop ring including a front end having a front stop wall, with the rear stop ring further including an inner periphery having a side stop wall and a recessed section, with the side stop wall configured for pressing against the second positioning ball, with the recessed section configured for partially receiving the second positioning ball, with the spring including two ends respectively abutting against the front stop ring and the front stop wall of the rear stop ring, and with the spring providing elasticity for movement of the sleeve body.

2. The tool coupler as claimed in claim 1, wherein the pressing seat is made of plastic material, and the elastic portion is helical.

3. The tool coupler as claimed in claim 1, with the first and second positioning balls being steel balls, with the recessed portion of the pressing seat including a notch intercommunicated with the receptacle, and with the magnet having a side exposed via the notch.

4. The tool coupler as claimed in claim 3, wherein the pressing seat further includes a first inclined guiding face between recessed portion and the pressing portion, and the first inclined guiding face inclines rearwards and radially outwards.

5. The tool coupler as claimed in claim 4, wherein the recessed section of the rear stop ring includes a front end having a front inclined guiding side.

6. The tool coupler as claimed in claim 1, wherein the coupling hole of the coupler includes an inner periphery having a shoulder located in front of the second radial hole, and a portion of the coupling hole in front of the shoulder has a diameter larger than a diameter of another portion of the coupling hole behind the shoulder.

7. The tool coupler as claimed in claim 1, wherein the outer periphery of the coupler includes a groove between the first and second positioning radial holes, and the front stop ring is received in the groove.

8. The tool coupler as claimed in claim 1, with the receiving hole of the sleeve body including a receiving portion behind the second inclined guiding face, with the receiving portion having an enlarged diameter larger than a diameter of a front portion of the receiving hole, and with the spring received in the receiving portion.
